(19) United States
(12) Patent Application Publication
(10) Pub. No.: US 2009/0006153 A1
(43) Pub. Date: Jan. 1, 2009

(54) Evaluation tool for adjusting resale of machine components

(76) Inventors: Jonny Ray Greiner, Dunlap, IL (US); Giles Kent Sorrells, Metamora, IL (US); Richard L. Gordon, East Peoria, IL (US); Anthony J. Grichnik, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/819,884

(22) Filed: Jun. 29, 2007

(51) Int. Cl. G06F 17/50

(52) U.S. Cl. 705/7

(57) ABSTRACT

A computer system for a prognostic evaluation system is provided. The computer system has a platform, at least one input device, and a central processing unit in communication with the platform and the at least one input device. The central processing unit is configured to receive use history information for a piece of equipment. The central processing unit is also configured to perform prognostic analysis based on the received use history information and to determine an estimated remaining life for the piece of equipment based on the prognostic analysis. The central processing unit is further configured to generate a report for the piece of equipment based on the prognostic analysis and to provide the generated report to a user.

### TECHNICAL FIELD

The present disclosure is directed to the field of prognostic evaluation and, more particularly, to a prognostic evaluation tool for adjusting resale of machine components.

### BACKGROUND

A typical evaluation machine, such as, for example, a tractor, dozer, loader, or other earthmover, as well as its corresponding components have a finite expected work life. The expected work life of the machine is determined, in part, by the designed work life of each individual component making up the machine. However, the actual life of a given component, and thus the actual life of the machine itself, may vary from machine to machine based on many factors including, for example, stresses to which the machine is subjected. Stresses that affect the work life of a machine and its components may include, for example, operating conditions, road layout and conditioning, weather conditions, loading practices, operator practices, and efficiencies.

The expected life of a machine or component corresponds to the actual life only when the actual work site resembles a “typical” or “reasonable” work site, upon which the designed life of each component is calculated or estimated. However, most work sites differ from a typical site in one or more of the stresses described above, which affect the machine and/or component life. Accordingly, the actual life of a machine or component seldom matches the designed life.

If a machine and its components are subject to stresses that are harsher than those experienced at a typical or theoretical work site, then the actual life of the machine and its corresponding components will be shorter than the designed life. On the other hand, if a machine is subjected to stresses that are less severe than experienced at the typical or theoretical work site, the actual life of the machine component may be longer than the designed life.

Machines have been increasing in both cost and complexity over the past few decades. In response, customers and equipment providers have been seeking ways to improve understanding of machine operating conditions considering, for example, cost, future scenarios, and logistics planning. Such knowledge is necessary in order to make informed decisions when acquiring new, used, and or reconditioned equipment. While a customer has particular equipment and machine needs, the ability of the customer to make informed decisions regarding machine, purchase, use, and sale depends on the degree of knowledge or information possessed by the particular individual making the decision.

Machine acquisition decisions are usually made by customers during a planning stage of the buying process. The process of decision making in machine acquisition requires knowledge about equipment, including equipment design and application, previous use, and stress or loads experienced by the machine and its components. By considering these aspects, a customer may make an informed decision regarding the actual remaining life of a machine or component and, thus, whether to acquire a particular piece of equipment. However, one customer's particular needs may be different than another's, even while employing similar equipment or while working in the same industry. Furthermore, different customers may have different degrees of prior knowledge, as well as experience in previous projects. As a result, customers may be more or less inclined to purchase used, remanufactured, or reconditioned machine parts based on the particular knowledge they possess. Without an appropriate tool, the process of selling used, remanufactured, or reconditioned machine parts, may be a time-consuming experience for machine dealers, especially when facing customers weary of the previous use of certain components in a resale part.

One tool that has been developed for evaluating a component or machine as it approaches an impending failure limit or point of unacceptable performance is described in U.S. Pat. No. 6,442,511 (the '511 patent) issued to Sarangapani et al. on Aug. 27, 2002. The '511 patent describes a method and system for determining a severity value of an operational trend, identifying a causal event or events thereof, and responding to the same. The method for determining a severity of a trend toward an impending machine failure includes the steps of providing a typical failure trend based on a set of normal operating conditions for the machine and determining a slope value for the typical failure trend. The method also includes determining a slope value for the trend toward the impending machine failure under the actual or proposed operating conditions. The method disclosed in the '511 patent further includes determining a weight value for at least the actual or proposed operating conditions, and determining the severity as a function of the slope values and the weight value.

Although the method of the '511 patent may provide a tool for failure diagnosis and prognosis, it may be unable to analyze previous use of a part or component in order to provide a report to a prospective customer, including a financial value on the remaining life. Similarly, the method described in the '511 patent does not provide an estimated remaining life of the component.

The present evaluation tool is directed to overcoming the one or more problems or disadvantages associated with the prior art.

### SUMMARY OF THE DISCLOSURE

In accordance with one aspect, the present disclosure is directed toward a computer readable medium, tangibly embodied, including instructions for receiving use history information for a piece of equipment and for performing prognostic analysis based on the received use history information. The medium includes instructions for determining an estimated remaining life for the piece of equipment based on the prognostic analysis. The medium further includes instructions to generate a report for the piece of equipment based on the prognostic analysis, and providing the generated report to a user.

According to another aspect, the present disclosure is directed toward a method for providing a prognostic tool. The method includes receiving use history information for a piece of equipment and performing prognostic analysis based on the received use history information. The method also includes determining an estimated remaining life for the piece of equipment based on the prognostic analysis. The method further includes generating a report for the piece of equipment based on the prognostic analysis and providing the generated report to a user.

### BRIEF DESCRIPTION OF THE DRAWINGS

FIG. 1 is a diagrammatic side view of an exemplary disclosed machine;

FIG. 2 is a diagrammatic representation of an exemplary disclosed electrical system for use with the machine of FIG. 1;

FIG. 3 is a block diagram of an exemplary disclosed electronic interface of the electrical system of FIG. 2;

FIG. 4 is a block illustration of an exemplary disclosed prognostic evaluation computer system for use with the electrical system of FIG. 2; and

FIG. 5 is a flowchart illustration of an exemplary disclosed method of operating the prognostic evaluation computer system of FIG. 4.

### DETAILED DESCRIPTION

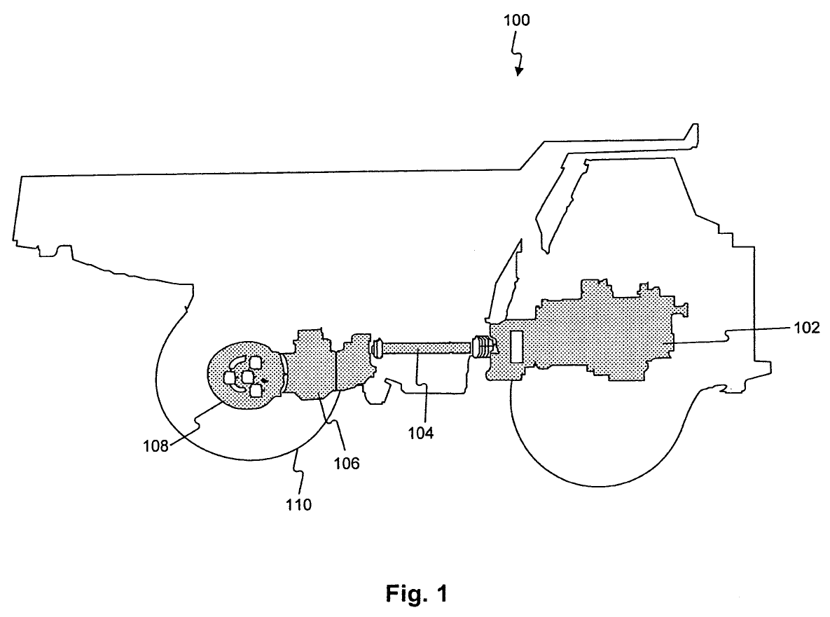

FIG. 1 includes a silhouette of a machine 100 showing exemplary components that may be monitored by a component life indicator. In the exemplary embodiment shown, machine 100 is a dump truck. However, machine 100 could be any other machine, such as for example, a tractor, a loader, an excavator, or another earth moving machine, as would be apparent to one skilled in the art. Machine 100 may be powered by an engine 102, which mechanically drives a transmission 106 by way of a drive shaft 104. The transmission 106 may be mechanically connected to a final drive assembly 108, which may, in turn, be mechanically connected to rear wheels 110 of machine 100. This driving arrangement of machine 100 could be any operable configuration, as would be apparent to one skilled in the art.

Because machine 100 may be used to carry heavy loads, a torque applied to the final drive assembly 108 could be very high in some situations, requiring robust components to withstand the high stresses. In order to measure the applied stresses, and predict the actual life of a final drive component, certain operational parameters should be known and considered. In order to obtain information on these parameters, sensors may be placed on various machine components to monitor the properties of the components.

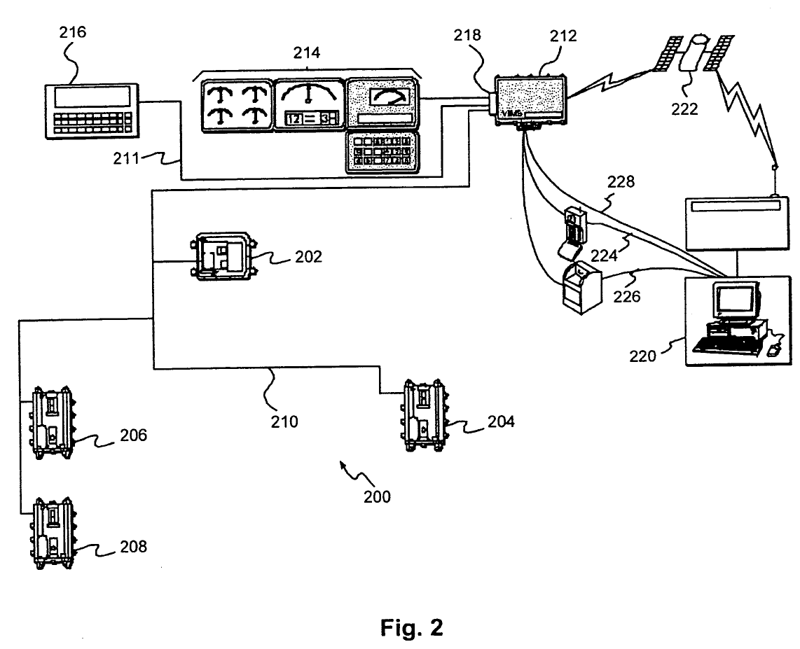

Turning to FIG. 2, an electrical system 200 for use with machine 100 is shown. Electrical system 200 may include a plurality of electronic control modules (ECM) 202-208, which may be associated with various sensors (not shown) for monitoring and recording a number of operating parameters that may be considered when determining a component life. Alternatively, these sensors may collect information that is stored on machine 100. The stored information may include load history information. The load history information may be stored in the form of a historical graph, table, or any other data structure. This information may be off-loaded to an off-board system upon request, automatically based on a elapsed period of time, or continuously.

For example, electrical system 200 may include an engine ECM 202. The engine ECM 202 may receive signals from engine sensors, such as, for example, an atmospheric pressure sensor, a fuel flow sensor, a boost pressure sensor, a water temperature sensor, an engine speed sensor, and an engine torque sensor. Additional sensors may be included to measure other properties of the engine, as necessary. These sensors may either provide a direct measurement of a key parameter relating directly to damage, or may provide a measurement value that may serve as a factor when determining damage. Additionally, evaluation of the information obtained by the sensors may aid operators and service personnel in determining when to perform maintenance or how best to operate the machine 100.

The electrical system 200 may also include a transmission ECM 204. The transmission ECM 204 may be associated with sensors for monitoring the transmission, that may include, for example, a gear code sensor, a transmission output speed sensor, torque output sensor, and a differential oil temperature sensor. Other sensors may be associated with the transmission ECM 204, as would be apparent to one skilled in the art. The electrical system 200 also may include a chassis ECM 206 and a brake/cooling ECM 208. Like the engine ECM 202 and the transmission ECM 204, the chassis ECM 206 and brake/cooling ECM 208 may be associated with various sensors for reading operational parameters of the components within the chassis and the brake/cooling systems. Other sensors and ECMs may be included for measuring properties of other components, as would be apparent to one skilled in the art. Each of these other ECMs, may be associated with one or more sensors, and the specific types of sensors and the number of sensors associated with any ECM may be determined by the application and information to be obtained by the sensors.

A display system 214 located on board machine 100 may electronically communicate with an interface 212. The display system 214 may include dials, gauges, a screen for showing numeric values, or any other display device capable of visually communicating a predicted remaining life of a machine component. In one exemplary embodiment, the display system 214 is a graphical display of visible lights that are activated to indicate the instantaneous magnitude of stresses applied to components and measured by the sensors associated with the ECMs in real-time. In another exemplary embodiment, the display system 214 includes an audible indicator that signals when the instantaneous applied stress exceeds a designated amount. In one embodiment, the display system 214 may display relevant information when the instantaneous applied stress exceeds a designated amount. For example, the display system 214 may show the stress level, the duration of time that the stress exceeds the designated amount, the time when the designated amount is exceeded, and the location of the machine 100 when the time is exceeded. This information may be stored for future reference. For example, this information may be off-loaded to an off-board system upon request, automatically based on an elapsed period of time, or continuously.

The display system 214 could alternatively be located remote from the machine 100. In one exemplary embodiment, display system 214 may even be omitted. Nevertheless, the information received by the interface 212 could be stored for access and viewing by a separate system, which may be located at a particular work site or at a remote location.

A service tool 216 may be used to electronically communicate with the interface 212 through a service link 211. The service tool 216 may allow a service technician to access the interface 212 to retrieve, view, download or analyze information stored in the interface 212. Further, the service tool 216 may be used to update stored information in the interface 212 to reflect, for example, maintenance performed or parts replaced, thereby keeping the component life indicator accurate. The service tool 216 may include a processor, a memory, an input and an output device (not shown), and may be capable of analyzing the information sent from the ECMs 202-208 and information generated by the interface 212. Alternatively, the service tool 216 may be a display for showing information to a service technician.

The service tool 216 may detachably connect to the interface 212 through an interface port 218 and be used to determine the effects of stress upon the machine components, as measured by the sensors. In one exemplary embodiment, the service tool 216 contains data structures that retrieve measured parameter data from the ECMs, including, for example, engine speed, fuel flow, boost pressure, water temperature, atmospheric pressure, gear code, differential gear oil temperature, and transmission output speed. The data structure may then calculate and determine, for example, an estimated remaining life of the final drive assembly 108 and/or individual components of final drive assembly 108.

The service tool 216 may be selectively connected to the interface 212 at servicing intervals to obtain information stored in interface 212, or could be permanently connected to the interface 212, as would be apparent to one skilled in the relevant art. In one exemplary embodiment, the service link 211 of the service tool 216 may electronically communicate directly with data link 210 to collect information on parameter measurements obtained by the sensors. In another exemplary embodiment, the service tool 216 contains no processor, but may be a memory element, such as a floppy disk, memory card or CD ROM, for receiving information from the interface 212, to be processed by a processor remote from the machine 100.

The interface 212 may transfer data such as, for example, load history information, to a prognostic evaluation system 220 for further analysis. Such analysis may include estimating a remaining life of a given component. Although all aspects of the prognostic evaluation system 220 could be located on-board the machine 100, the prognostic evaluation system 220 may allow analysis to be conducted remotely, and may allow a fleet of machines to be monitored at a central location, if desired.

In one exemplary embodiment, such data may be transferred by a satellite transmission system 222 from the interface 212 to the prognostic evaluation system 220. Alternatively, the data may be transferred by a wired or a wireless telephone system 224 including a modem, or by storing data on a computer disk, which may then be mailed to the central computer site using a mailing system 226. As a further alternative, each machine 100 may be driven to a location near the prognostic evaluation system 220, and directly linked to the prognostic evaluation system 220 using a central computer link 228. Other data transfer methods may be used, as would be apparent to one skilled in the art, including transmitting data through a transmitter associated with the interface 212 to a receiver located remote from the machine 100.

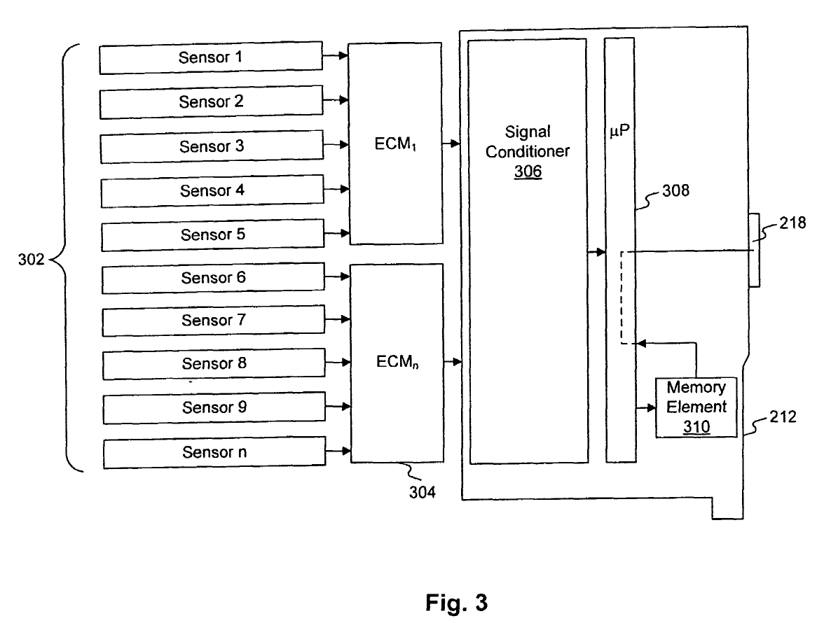

FIG. 3 is an exemplary embodiment of the interface 212 showing components of the electrical system 200. As seen in FIG. 3, a number of property sensors 302 may be associated with, and send signals to any number of ECMs 304, which, in turn, may electrically communicate with the interface 212. A signal conditioner 306 included within the interface 212 may receive electrical data signals sent by the ECMs 304 and scale, buffer, or otherwise filter the data signals to a processable signal, as is known in the art. In one exemplary embodiment, the signal conditioner 306 may be housed within each ECM or sensor body, and therefore, would not be contained within the interface 212.

The signal conditioner 306 may communicate with a processor 308, which may be in communication with a memory element 310. The memory element 310 may record the sensed parameter values and information collected from the ECMs 304, and may also include data structures and algorithms that represent component models such as, for example, an engine life model, a lower drive life model, and a final drive life model.

Further, when the remaining life of a component is estimated by calculating an instantaneous damage summed over the component's life, the memory element 310 may be used to store the accumulating sum of damage. Similarly, when parts are repaired or replaced, the information in the memory element 310 may be reset or adjusted to reflect the new or repaired state of the component. Additionally, when an instantaneous stress exceeds a designated value, the memory element 310 may store or log additional parameters that may be useful to a service person to repair or maintain the machine components. These additional parameters may include, for example, the time, duration, level of stress or damage, and location of the machine when the damage occurred.

The processor 308 may retrieve stored data structures or information from the memory element 310, input the conditioned parameter values sent by the ECMs 304 into the data structures, and compute various output values such as the remaining work life of a component. The interface 212 may receive data signals from the ECMs 304 in real-time, and instantaneously convert the data signals into values that may be recorded on the memory element 310 or outputted to the display system 214 of FIG. 2 through the interface port 218. Interface 212 may also transmit the collected data to a prognostic evaluation system 220, which may perform prognostic analysis to determine an estimated remaining life of a given component.

It is contemplated that the parameter sensors 302 may be in direct electrical communication with the interface 212, bypassing the ECMs 304, if desired. Further, the ECMs 304 may filter, alter, change, or combine electrical signals from the sensors 302 prior to communicating the signals to the interface 212. Additionally, as used in the present disclosure, the description and recitation of a sensor may include both the parameter sensors 302 and the ECMs 304, which may calculate parameters based on signals from the sensors 302.

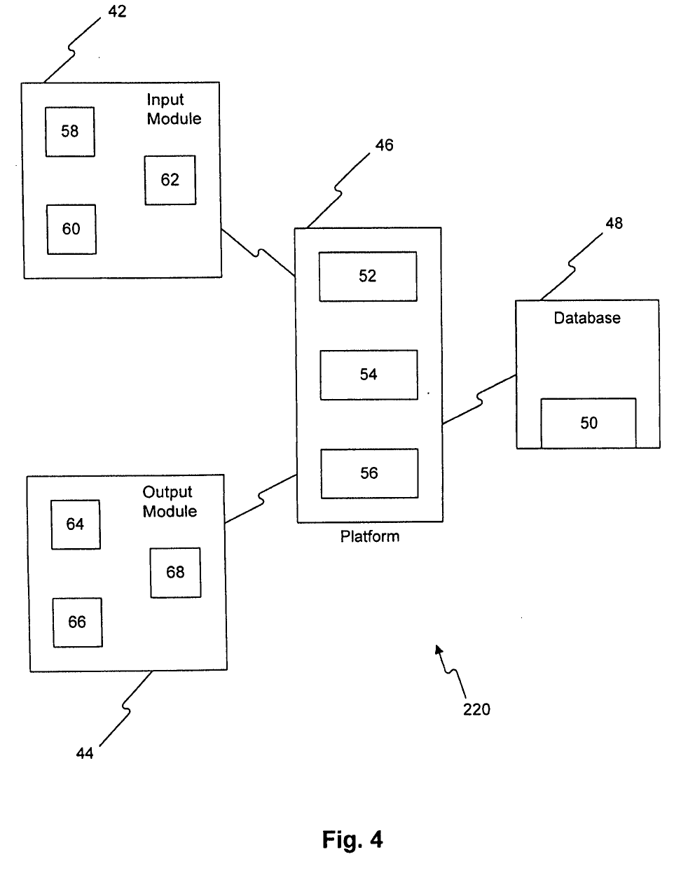

FIG. 4 illustrates an exemplary prognostic evaluation system 220. System 220 may include an input module 42, an output module 44, and a computing platform 46. Computing platform 46 may include or may be otherwise operatively coupled to a database 48 having a memory 50. Database 48 may include more than one database or another type of electronic repository. Computing platform 46 may include the necessary functionality and computing capabilities to implement prognostic evaluation strategies through input module 42 and access, read, and write to database 48.

The results of input received from sensors 302, ECMs 304, and/or a user may be provided as output from computing platform 46 to output module 44 for printed display, viewing, and/or further communication to other system devices. Such output may include, for example, reports, information packages, estimates and results, or asset information obtained from the prognostic evaluation system 220 for the user's reference or for prospective customers. Output from computing platform 46 can also be provided to database 48, which may be utilized as an additional storage device for prognostic evaluation information.

In the embodiment of FIG. 4, computing platform 46 may include a personal computer (PC) or mainframe computer configured to perform various functions and operations. Computing platform 46 may be implemented, for example, by a general purpose computer selectively activated or configured by a computer program stored in memory of the computer, or may be a specially constructed computing platform for carrying out the features and operations of prognostic evaluation system 220. Computing platform 46 may also be implemented or provided with a wide variety of components or subsystems including, for example, one or more of the following: a processor 52, a co-processor 54, a register 56, and/or other data processing devices and subsystems. Computing platform 46 may also communicate or transfer prognostic evaluation strategies, estimates, or reports to input module 42 and/or from output module 44 through the use of direct connections or other communication links, as illustrated in FIG. 4. In an exemplary embodiment, a firewall may prevent access to the computer platform 46 by unauthorized outside entities. It is further contemplated that computing platform 46 may require user authentication, such as password verification, in order to prevent unauthorized users from gaining access to prognostic information from a particular customer or provider.

It is further contemplated that communication between computing platform 46 and input and output modules 42, 44 can be achieved through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, the computing platform 46 may be located in the same location or at a location geographically remote from the input and/or output modules 42, 44.

Input module 42 may include a wide variety of devices to receive and/or provide the data as input to computing platform 46. As illustrated in FIG. 4, input module 42 may include an input device 58, a storage device 60, and/or a network interface 62. Input device 58 may include a keyboard, a mouse, a touchscreen, a disk drive, a video camera, a magnetic card reader, or any other suitable input device for providing data to computing platform 16. Memory 50 may be implemented with various forms of memory or storage devices, such as read-only memory (ROM) devices and random access memory (RAM) devices. Storage device 60 may include a memory tape or disk drive for reading and providing data as input to computing platform 46. Network interface 62 may receive data over a network (such as a LAN, WAN, intranet or the Internet) and provide the same data as input to computing platform 46. For example, network interface 62 may be connected to a public or private database for the purpose of receiving information about customers, machines or components from computing platform 46.

Output module 44 may include a display 64, a printer device 66, and/or a network interface 68 for receiving the results provided as output from computing platform 46. As indicated above, the output from computing platform 46 may include one or more prognostic evaluation strategies, estimates, reports, or asset information obtained from the prognostic evaluation system 220 for the user's reference or to be provided to prospective customers. The output from computing platform 46 may be displayed or viewed through display 64 (such as a CRT or LCD) and printer device 66. Network interface 68 may also facilitate the communication of the output from computing platform 46 over a network (such as a LAN, WAN, intranet or the Internet) to remote locations for further analysis, viewing or storing.

Prognostic evaluation information applicable to machine 100 or components thereof may be stored within memory 50 of database 48. Database 48 may include data relevant to load history information. Database 48 may further include data directed to operating conditions (e.g. cold, heated, etc.), and hours of use. Such data may include various information that may impact or otherwise relate to machine and component operation and use.

It is further contemplated that prognostic evaluation system 220 may obtain machine and component information from sources other than database 48, which may be either public or private. This information may be obtained in order to develop, deliver, and/or execute prognostic evaluation content tailored to a user's particular needs, a particular machine model or relevant part. Examples of information obtained from other databases may include market information, such as external price drivers, market analysis, and competitor prices.

Although the disclosed implementation may include a particular network configuration, embodiments of the present disclosure may be implemented in a variety of data communication network environments using software, hardware, or a combination of hardware and software to provide the processing functions. Those skilled in the art will appreciate that all or part of systems and methods consistent with the present disclosure may be stored on or read from other computer-readable media. Thus, system 220 may include a computer-readable medium, having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 40, such as, for example, computing platform 46, database 48, memory 50, processor 52, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The information reports, packages, performance estimates and results, or machine and component information obtained from the prognostic evaluation system for the user's reference may include paper documents, electronic documents, Internet-based documents, and any other suitable media for documentation. The packages or reports may also include electronic documents, such as computer files. Such files may be provided to members of the target population, such as prospective customers via various modes of transmission, including email. Internet-based documents may include word processor type files and/or webpages, which may include the prognostic evaluation-related information, estimates, and/or reports. Administration of such documents may include notifying members in any suitable way of the availability and/or accessibility of such documents, including updates to existing content, and may provide an Internet address for accessing the documents or related reports.

Implementation of the disclosed system may be, to some extent, undertaken by hand. For example, the determination of which information will be provided to individual users of the target population and/or the assembly of reports may be handled by one or more persons, e.g., representatives, managers or administrators of the machinery providing entity. It is contemplated, however, that either a manual, semi-computerized, or fully computerized implementation may be utilized.

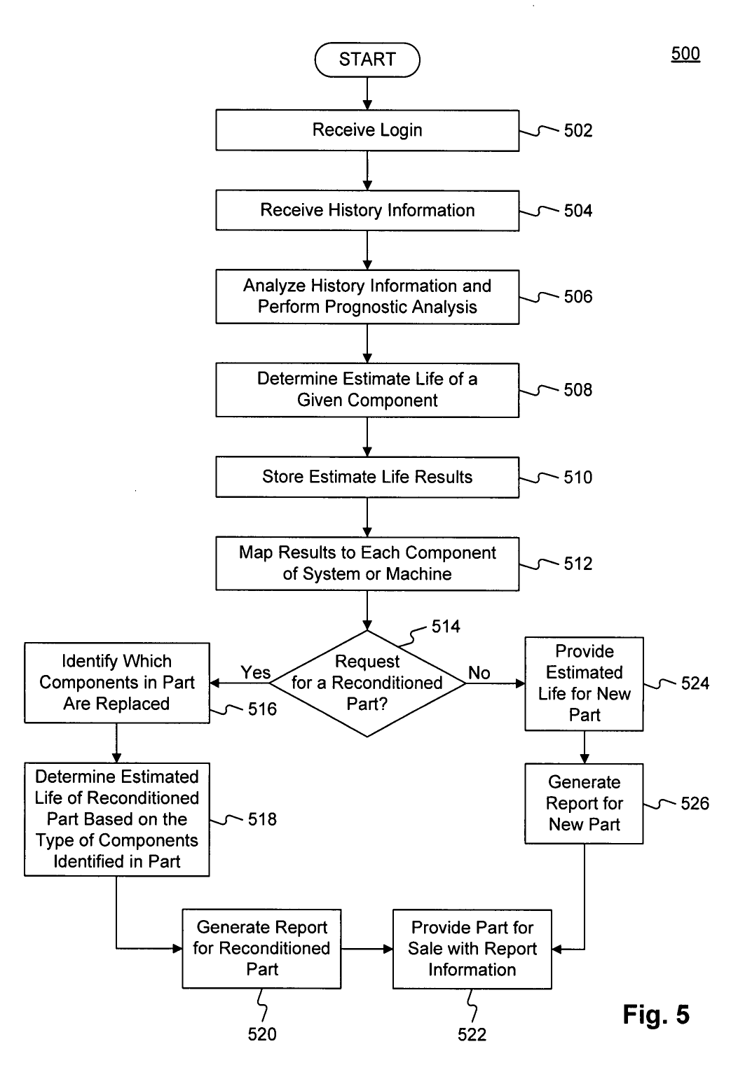

FIG. 5 illustrates a flowchart 500 depicting an exemplary method performed by prognostic evaluation system 220 to prognosticate an analysis of previous use and/or operating conditions for a piece of equipment in order to provide assistance to a user or customer during an equipment buying process. The method depicted in flowchart 500 will be described in more detail below.

### INDUSTRIAL APPLICABILITY

The disclosed method and system may allow customers or machinery providers to determine an estimated remaining life of a given component, based on collected information. In particular, the disclosed method and system may assist in the buying stage of a particular project, based on a user's particular equipment and economic needs. In this manner, a current or prospective customer, who is in the buying or equipment acquiring stage of a project, may be provided with a report that captures existing and available equipment, its use history information and operating conditions, an expected useful life remaining, as well as a related sales price based on the use history. The user of the disclosed prognostic evaluation tool may then make an informed decision when planning, selecting, changing, or buying the equipment implemented in a particular project.

As illustrated in FIG. 5, the first step in the functioning of the prognostic evaluation system 220 may include receiving a log-in from a user (Step 502). The log-in procedure may be completed via input module 42, including input device 58. During log-in, a user may also enter information related to particular business aspects, such as, for example, type of machine, type of project, company or prior business relationship with the machinery provider. During step 502, the user may also indicate whether he or she is interested in a used part, remanufactured part, or reconditioned part available for sale.

Upon receipt and verification of log-in information, the prognostic evaluation tool located on the prognostic evaluation system 220 may be initialized. Initialization may include the prognostic evaluation system 220 receiving from a particular machine 100, user or database, history information about the machine 100 (Step 504). This information may be collected from sensors and other related devices located on the machine 100. This information may be previously available on the machine 100, and off-loaded to the prognostic evaluation system 220 automatically or upon request by a user or prospective customer. It is further contemplated that the history information may be obtained by a tracking operation (not shown). For example, the tracking operation may include maintaining records related to a piece of equipment and its corresponding serial number. Tracking data associated with the serial number corresponding to the particular piece of equipment may then be provided to the prognostic evaluation system 220 automatically or upon request. Furthermore, the particular history information may include load history information, operating conditions (such as cold or hot environments), hours of operation or any other information related to previous use of the machine 100 or a component of the machine 100.

Prognostic evaluation system 220 may then analyze the received history information and perform a prognostic analysis (Step 506). Alternatively, it is also contemplated that components located on the particular machine may be configured to perform the prognostic analysis.

As part of the prognostic analysis, the prognostic evaluation system 220 may determine or calculate a damage factor for components of machine 100. This calculated damage factor may be based on use of the machine over a period of time at the actual work site, such as, for example, two weeks. The calculated damage factor may be plotted on a graph generated by the prognostic evaluation system 220.

As part of the prognostic analysis, a curve may be fitted to the damage factor plot. For example, the curve may be determined and provided using a method of linear regression. The slope of the generated curve may be calculated using known methods. Once the slope of the generated curve is calculated, the curve may be projected to estimate the component life as part of the prognostic analysis.

The calculated slope of the plotted curve may be compared to a typical use slope to determine whether the calculated slope is steeper than the typical use slope. The typical use slope is the slope of a damage factor plot for a theoretical use site, for the particular piece of equipment. The typical use slope may be based upon the predicted damage for a designed component or piece of equipment, or based upon data received over time regarding component failure in prior machines or equipment. If the calculated slope is steeper or has a higher slope than the typical use slope, the prognostic evaluation system 220 may determine the remaining or estimated useful life, which, in this case, may be lower than the theoretical or designed work life for the particular piece of equipment. If the slope of the generated curve is less steep or equal to the typical slope, the prognostic evaluation system may determine that the remaining or estimated useful life in this case may be longer than the theoretical or designed work life for the particular piece of equipment. The components on the machine may also store the results for subsequent access by the prognostic evaluation system 220.

Prognostic evaluation system 200 may quantify the amount of remaining component life based upon a table prepared for such purposes. The table could indicate that a slope value within a certain range indicates that a remaining or estimated useful life may be set to a particular value. Moreover, the remaining or estimated useful life may be based upon the damage factor itself. Accordingly, if the damage factor falls within a given range, or averages a given value, then the remaining or estimated useful life may also fall within a given range.

The prognostic analysis described with reference to Step 506 may also be used to provide a value (i.e., sales price) and/or terms of new warranty contracts already in effect. Alternatively, the prognostic analysis described with reference to Step 506 may be used to modify the terms of existing warranty contracts. For example, by knowing the remaining or estimated useful life of components, machinery dealers may be able to consider factors that affect a component's useful life. As factors change, the machinery dealer may choose to modify the terms and/or price of warranty contract. For example, roads at a work site may erode, making the roads rougher and causing more damage to machine components. In this situation, the machine dealer may increase the price of a warranty contract to correspond with the increased damage likely to occur as a result of the rougher roads.

As part of the method, prognostic evaluation system 220 may determine an estimated remaining life of a given component (Step 508), based on the prognostic analysis. The prognostic evaluation system 220 may then store the obtained estimated remaining life results for a given component (Step 510). The prognostic evaluation system 220 may map the results to each component of the particular system or machine (Step 512). Furthermore, at Step 512, each component may be associated with the machine 100 on which it is located.

The prognostic evaluation system 220 may then determine whether information relating to a reconditioned part is requested (Step 514). During reconditioning of a given part, a prognostic tool stored on the prognostic evaluation system 220 may identify which component(s) of machine 100 have been serviced or replaced and which component(s) have not (Step 516). If the part has been reconditioned, the prognostic evaluation system 220 may re-determine the estimated remaining life of the reconditioned part based on the type of components (i.e. reconditioned or not) included within the part (Step 518). The estimated remaining life of the reconditioned part may be determined, at least in part, by the estimated remaining life of the individual components, obtained by performing a prognostic analysis based on history information received for the individual components.

The prognostic evaluation system 220 may then summarize the information generated by the prognostic tool in a report (Step 520). For example, the prognostic evaluation system 220 may summarize in the report: the components used in the remanufactured part, the history of previous use for each component, identification of the type of machine where the component was previously used, the type of environment where the component was used (e.g., cold or hot; clean or dirt; low or high altitudes), hours of operation, as well as any other information relating to prior use of the component.

The prognostic evaluation system 220 may then provide a machine part for sale, including the generated report information and a sales price for the part (Step 522). The part may be packaged with the report or the report may be linked in an on-line sales environment with the content reflecting the reconditioned part. The report generated by the prognostic evaluation system 220 may be presented to or retrieved by a prospective customer of the particular part. The customer may make an assessment as to whether the value of the part is worth the sales price, based on the information provided in the report, including history information and the estimated remaining life for the particular part.

In case the prognostic evaluation system 220 determines that a reconditioned part has not been requested, the prognostic evaluation system 220 may provide an estimated life for a new part (Step 524). The prognostic evaluation system 220 may also provide a report for the new part (Step 526). For example, the prognostic evaluation system 220 may summarize in the report the components used in the new part, that there is no history of previous use for any component, as well as any other information relating to prospective use of the component. Accordingly, the prognostic evaluation system 220 may then provide the machine part for sale, including the generated report information and a sales price for the new part (Step 522). The part may be packaged with the report or, in an on-line sales environment, the report may be linked with the content reflecting the new part. The report generated by the prognostic evaluation system 220 may be presented to or retrieved by a prospective customer of the new part. The customer may make an assessment as to whether the value of the new part is worth the sales price, based on the information provided in the report, including history information and estimated life for the new particular part.

It is further contemplated that in addition to determining an estimated life for a new part or machine, prognostic evaluation system 220 may also determine, automatically or upon request, a resale price for the part once it has been used and reconditioned, based at least on the analyzed history information of a similar part in a similar application. In order to determine the resale price for a piece of equipment, it is contemplated that prognostic evaluation system 220 may analyze or consider other market information, such as external price drivers, market analysis, and competitor prices. The generated sales price may be provided in the report generated for the particular piece of equipment.

It is also contemplated that in addition to determining an estimate life or resale price for a component, part or machine, prognostic evaluation system 220 may be configured to further determine, automatically or upon request, warranty information for a reconditioned part, based at least on the analyzed history information. The warranty price and terms for a reconditioned part may be also be based, at least in part, on the estimated remaining life for the part or machine. In order to determine the warranty price and terms of coverage for a piece of equipment, it is contemplated that prognostic evaluation system 220 may also analyze or consider other market information, such as external price drivers, market analysis, and competitor prices.

The prognostic evaluation system 220 thus may provide a tool for analyzing previous use of a part or component in order to provide a report to a prospective customer. The method performed by the prognostic evaluation system may provide an estimated remaining life of the component. For example, a user may be interested in purchasing a driveline that was previously implemented in a wheel loader. For example, the used driveline may be intended to last 10 years in the wheel loader when used at a load less or equal to a design (or “target”) payload for 2000 hours each year in a relatively clean environment at an average temperature of 75 degrees. However, if the driveline is 2 years old and was overloaded 15 times in excess of 20% of its design payload for 300 hours in a sandy environment, the remaining useful life may be expected to be less (i.e., 4 years). The method performed by the prognostic system 220 may provide a price for the particular piece of equipment based on use information, such as a damage factor. Furthermore, a machinery dealer may offer a reduced warranty contract, based on this information. For example, the dealer may offer a prospective customer a warranty contract for only one year. The prospective purchaser of the driveline may then make an informed decision when planning, selecting, changing, or purchasing the driveline.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims.

What is claimed is:

1. A computer-readable medium, tangibly embodied, including instructions for:
receiving use history information for a piece of equipment;
performing prognostic analysis based on the received use history information;
determining an estimated remaining life for the piece of equipment based on the prognostic analysis;
generating a report for the piece of equipment based on the prognostic analysis; and
providing the generated report to a user.

2. The computer-readable medium of claim 1, wherein the received history information includes information related to previous use of the equipment, including at least one of load history information, operating environment conditions, and hours of operation.

3. The computer-readable medium of claim 2, wherein the generated report includes an estimated remaining life for the piece of equipment.

4. The computer-readable medium of claim 3, further including instructions for providing the report in an on-line sales environment.

5. The computer-readable medium of claim 3, further including instructions for providing a package to the user, the package having an identification of the piece of equipment and the generated report corresponding to the piece of equipment.

6. The computer-readable medium of claim 5, wherein the generated report further includes a resale price associated with the piece of equipment, the resale price being based on the estimated remaining life.

7. The computer-readable medium of claim 6, wherein the generated report further includes a warranty price and warranty terms of coverage, the warranty price and terms of coverage being based on the estimated remaining life.

8. A method for providing a prognostic tool, comprising:
receiving use history information for a piece of equipment;
performing prognostic analysis based on the received use history information;
determining an estimated remaining life for the piece of equipment based on the prognostic analysis;
generating a report for the piece of equipment based on the prognostic analysis; and
providing the generated report to a user.

9. The method of claim 8, wherein the received history information includes information related to previous use of the equipment, including at least one of load history information, operating environment conditions, and hours of operation.

10. The method of claim 9, wherein the generated report includes an estimated remaining life for the piece of equipment.

11. The method of claim 10, further including instructions for providing the report in an on-line sales environment.

12. The method of claim 10, further including instructions for providing a package to the user, the package having an identification of the piece of equipment and the generated report corresponding to the piece of equipment.

13. The method of claim 12, wherein the generated report further includes a resale price associated with the piece of equipment, the resale price being based on the estimated remaining life.

14. The method of claim 13, wherein the generated report further includes a warranty price and warranty terms of coverage, the warranty price and terms of coverage being based on the estimated remaining life.

15. A computer system, comprising:
a platform;
at least one input device; and
a central processing unit in communication with the platform and the at least one input device, the central processing unit configured to:
receive use history information for a piece of equipment;
perform prognostic analysis based on the received use history information;
determine an estimate life for the piece of equipment based on the prognostic analysis;
generate a report for the piece of equipment based on the prognostic analysis; and
provide the generated report to a user.

16. The computer system of claim 15, wherein the received history information includes information related to previous use of the equipment, including at least one of load history information, operating environment conditions, and hours of operation.

17. The computer system of claim 16, wherein the generated report includes an estimated remaining life for the piece of equipment.

18. The computer system of claim 17, wherein the central processing unit is further configured to provide the report in an on-line sales environment or as part of a package to the user, the package having an identification of the piece of equipment and the generated report corresponding to the piece of equipment.

19. The computer system of claim 18, wherein the generated report further includes a resale price associated with the piece of equipment, the resale price being based on the estimated remaining life.

20. The computer system of claim 19, wherein the generated report further includes a warranty price and warranty terms of coverage, the warranty price and terms of coverage being based on the estimated remaining life.
